(19) United States
(12) Patent Application Publication
(10) Pub. No.: US 2019/0308618 A1
(43) Pub. Date: Oct. 10, 2019

(54) DRIVING SUPPORT APPARATUS

(71) Applicant: TOYOTA JIDOSHA KABUSHIKI KAISHA, Toyota-shi (JP)

(72) Inventors: Satoshi KONDO, Numazu-shi (JP); Yuji Yoshioka, Susono-shi (JP)

(73) Assignee: TOYOTA JIDOSHA KABUSHIKI KAISHA, Toyota-shi (JP)

(21) Appl. No.: 16/371,187

(22) Filed: Apr. 1, 2019

(30) Foreign Application Priority Data
Apr. 4, 2018 (JP) 2018-072356

(51) Int. Cl. B60W 30/095

(52) U.S. Cl. CPC B60W 30/0953; B60T 8/17558

(57) ABSTRACT

A driving support apparatus is provided with: an executor configured to perform a collision avoidance assist control, on a first vehicle; an acquirer configured to obtain surrounding information including information about a second vehicle, which has a possibility of colliding with the first vehicle, and information about a third vehicle, which has a possibility of colliding with the second vehicle; a predictor configured to predict whether or not the second vehicle changes a travel aspect due to a presence of the third vehicle, on the basis of the surrounding information; and a controller programmed to control the executor not to perform the collision avoidance assist control if it is predicted that the second vehicle changes the travel aspect, and to control the executor to perform the collision avoidance assist control if it is predicted that the second vehicle does not change the travel aspect.

### CROSS-REFERENCE TO RELATED APPLICATIONS

This application is based upon and claims the benefit of priority of the prior Japanese Patent Application No. 2018-072356, filed on Apr. 4, 2018, the entire contents of which are incorporated herein by reference.

### BACKGROUND

### 1. Technical Field

Embodiments of the present disclosure relate to a driving support apparatus configured to support the driving of a vehicle.

### 2. Description of the Related Art

For this type of apparatus, there is known an apparatus that uses information about a vehicle that has a possibility of colliding with a host vehicle in order to avoid a collision between the vehicles. For example, Japanese Patent Application Laid Open No. 2008-084005 (Patent Literature 1) discloses a technology/technique of avoiding a possible collision in giving way or yielding the right of way, by sending a message to the other vehicle and by providing information based on the message, in view of travel environments of the host vehicle and the other vehicle.

In the technology/technique described in the Patent Literature 1, the goal is to avoid a collision of the host vehicle in the give way in a situation in which the host vehicle is a target of the give way. On the other hand, in the technology/technique described in the Patent Literature 1, no consideration is given to avoiding a collision of the host vehicle in a situation in which the host vehicle is not related to the give way, which is particularly a collision with one of the vehicles that are targets of the give way. Thus, in the technology/technique described in the Patent Literature 1, there is room for improvement in avoiding the collision between the host vehicle and one of the vehicles that are the targets of the give way in the situation in which the host vehicle is not related to the give way.

Specifically, even if there may be a possibility of the collision between the host vehicle and one of the vehicles that are the targets of the give way at the beginning, the give way may result in little or no possibility of the collision between the host vehicle and the one of the vehicles that are the targets of the give way. In the technology/technique described in the Patent Literature 1, however, an assist for avoiding the collision between the host vehicle and the vehicle that has little or no possibility of colliding with the host vehicle, i.e., the one of the vehicles that are the targets of the give way, may be performed on the host vehicle because the result of giving way is not considered. In other words, an assist with a relatively low necessity may be performed, which is technically problematic.

### SUMMARY

In view of the aforementioned problems, it is therefore an object of embodiments of the present disclosure to provide a driving support apparatus configured to perform an assist control for avoiding a collision between vehicles.

The above object of embodiments of the present disclosure can be achieved by a driving support apparatus provided with: an executor configured to perform a collision avoidance assist control for avoiding a collision with another vehicle, on a first vehicle; an acquirer configured to obtain surrounding information including information about a second vehicle, which has a possibility of colliding with the first vehicle, and information about a third vehicle, which has a possibility of colliding with the second vehicle; a predictor configured to predict whether or not the second vehicle changes a travel aspect due to a presence of the third vehicle, on the basis of the surrounding information; and a controller programmed (i) to control the executor not to perform the collision avoidance assist control for avoiding the collision with the second vehicle if it is predicted that the second vehicle changes the travel aspect due to the presence of the third vehicle, and (ii) to control the executor to perform the collision avoidance assist control for avoiding the collision with the second vehicle if it is predicted that the second vehicle does not change the travel aspect due to the presence of the third vehicle.

### DETAILED DESCRIPTION OF THE EMBODIMENTS

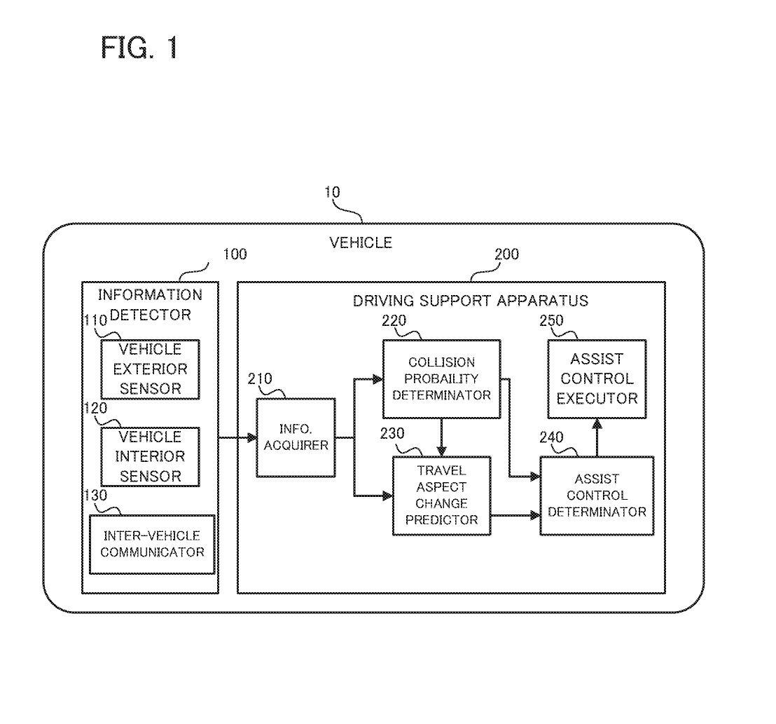

FIG. 1 is a block diagram illustrating a configuration of a vehicle according to a first embodiment;

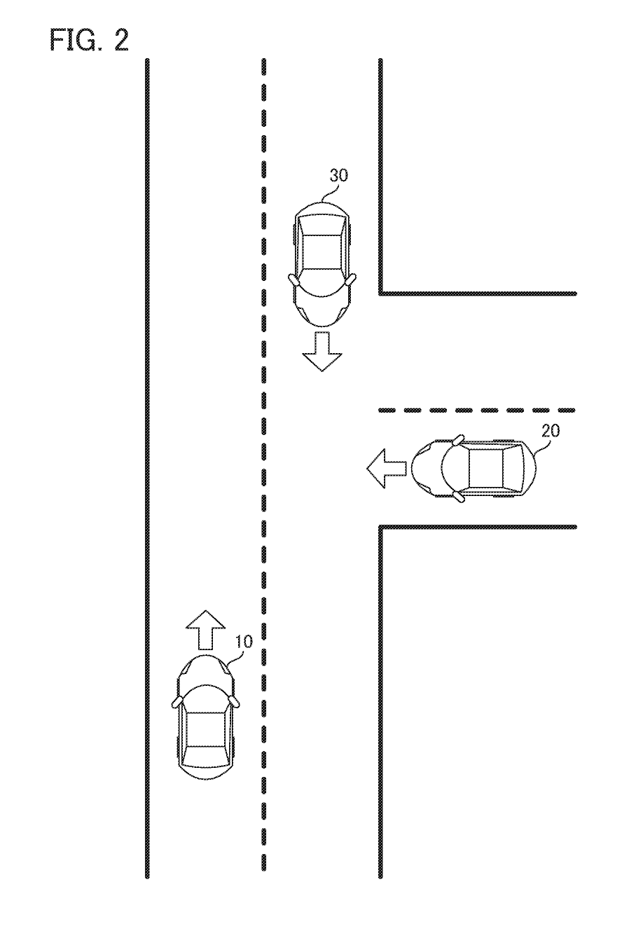

FIG. 2 is a plan view illustrating an example of a collision case assumed by a driving support apparatus according to the first embodiment;

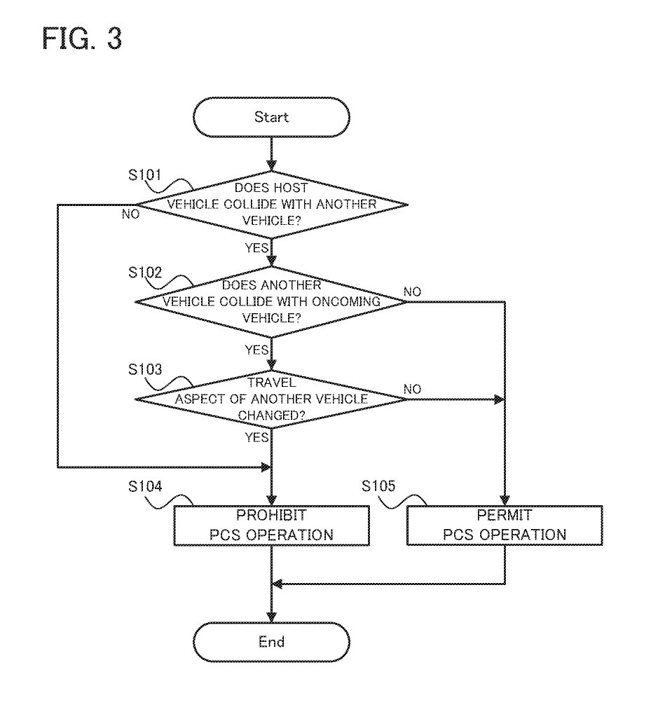

FIG. 3 is a flowchart illustrating a flow of operations of the driving support apparatus according to the first embodiment;

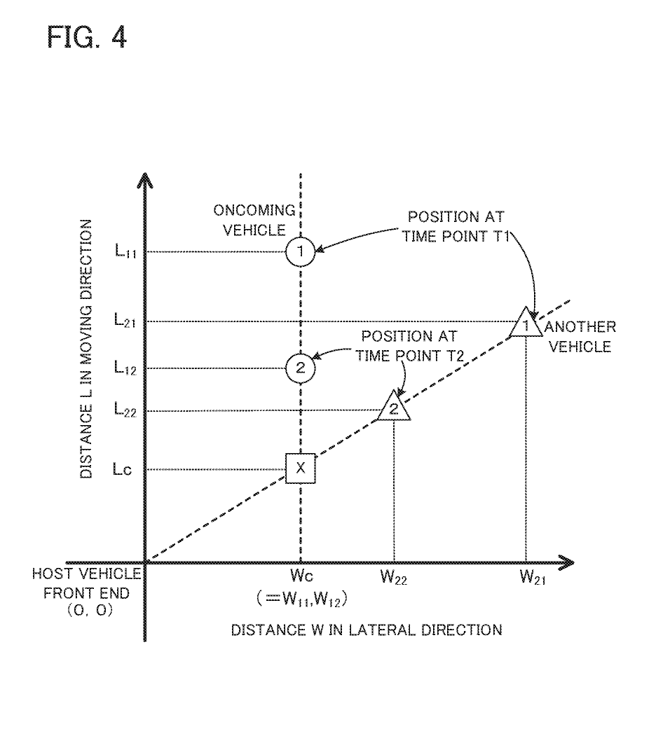

FIG. 4 is a graph illustrating a method of calculating a collision point between an oncoming vehicle and another vehicle;

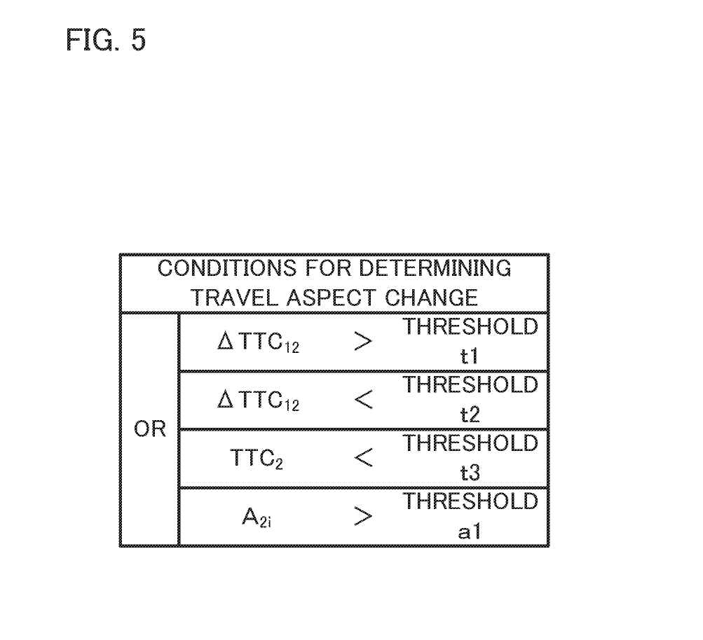

FIG. 5 is a table indicating conditions for determining whether or not the other vehicle changes a travel aspect due to the presence of the oncoming vehicle;

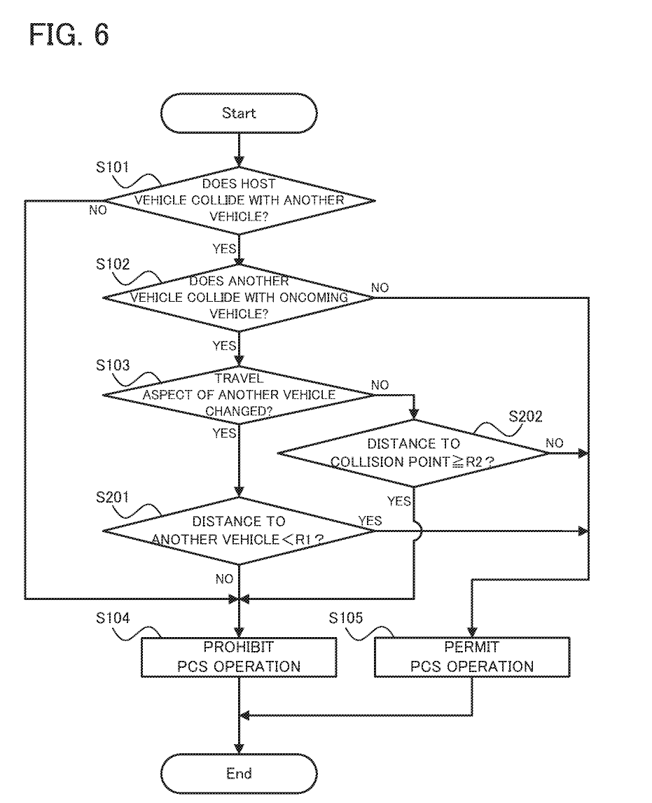

FIG. 6 is a flowchart illustrating a flow of operations of a driving support apparatus according to a second embodiment;

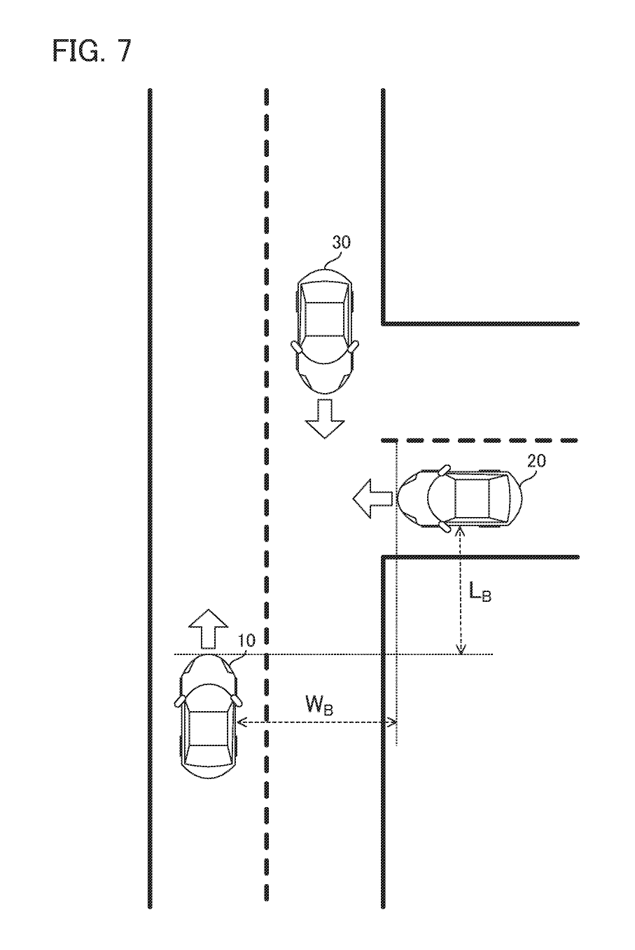

FIG. 7 is a plan view illustrating an example of a case in which the host vehicle is close to the other vehicle;

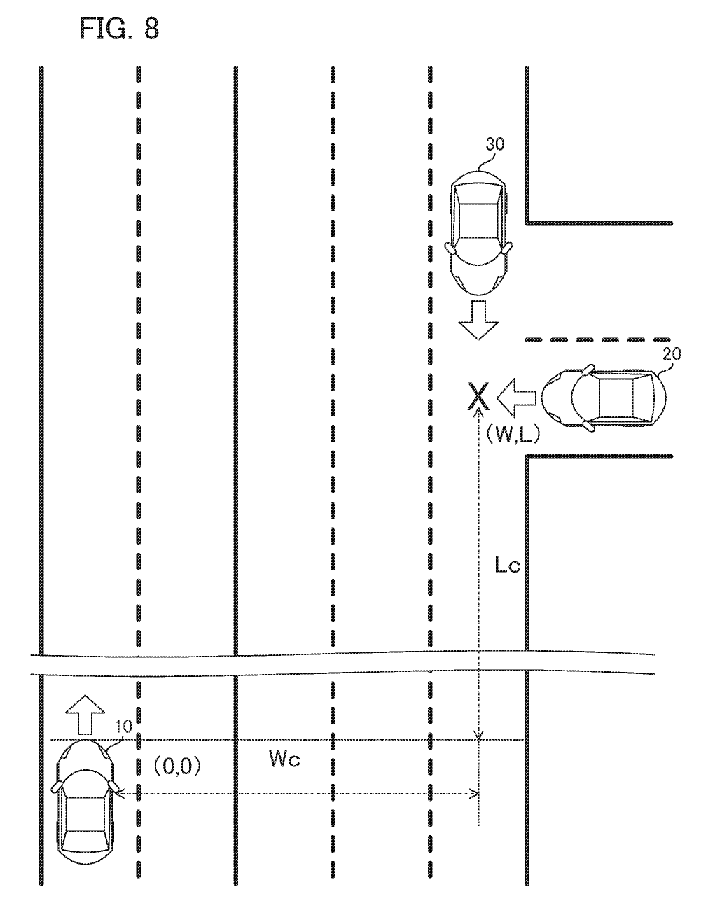

FIG. 8 is a plan view illustrating an example of a case in which the host vehicle is far from a collision point;

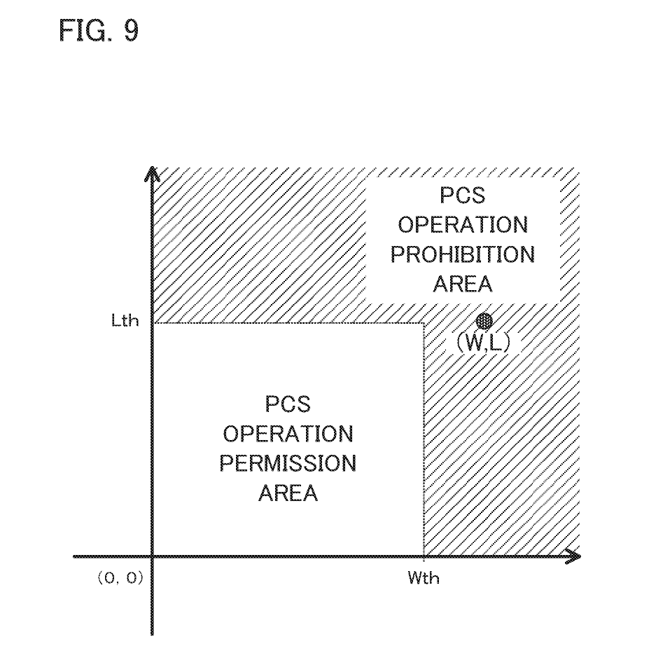

FIG. 9 is a map illustrating an operation permission area and an operation prohibition area of a PCS control; and

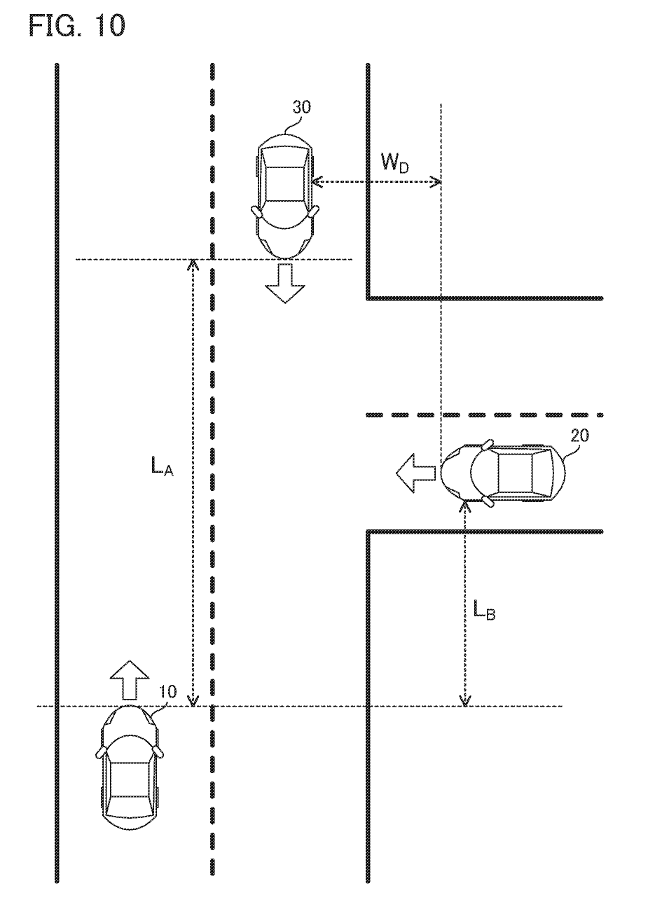

FIG. 10 is a plan view illustrating a method of determining giving way or yielding the right of way on a driving support apparatus according to a third embodiment.

### DETAILED DESCRIPTION OF THE EMBODIMENTS

A driving support apparatus according to embodiments of the present disclosure will be explained with reference to the drawings.

### First Embodiment

A driving support apparatus according to a first embodiment will be explained with reference to FIG. 1 to FIG. 5. Hereinafter, a configuration, operations, and a technical effect of the driving support apparatus according to the first embodiment will be explained in order.

<Configuration of Apparatus>

Firstly, an explanation will be given to an entire configuration of a vehicle on which the driving support apparatus according to the first embodiment is mounted, with reference to FIG. 1. FIG. 1 is a block diagram illustrating the configuration of the vehicle according to the first embodiment.

As illustrated in FIG. 1, a vehicle 10 according to the first embodiment is provided with an information detector 100 and a driving support apparatus 200. The vehicle 10 is a specific example of the “first vehicle” in Supplementary Notes described later.

The information detector 100 is provided with a vehicle exterior sensor 110, a vehicle interior sensor 120, and an inter-vehicle communicator 130. The vehicle exterior sensor 110 may include, for example, a camera, a radar, a lidar, or the like, and is configured to obtain information about an external environment of the vehicle 10 (hereinafter referred to as a “host vehicle 10” as occasion demands), which is particularly information about another vehicle that exists around the host vehicle 10. The vehicle interior sensor 120 may include various sensors, such as, for example, a vehicle speed sensor and an acceleration sensor, or the like, and is configured to obtain various information about the host vehicle 10. The inter-vehicle communicator 130 is configured to obtain various information about the other vehicle, which is particularly information that cannot be detected by the vehicle exterior sensor 110, by making communication between the host vehicle 10 and the other vehicle. The inter-vehicle communicator 130 may perform a road-to-vehicle communication, or may be a communicator, such as a mobile phone.

Information detected on each of the vehicle exterior sensor 110, the vehicle interior sensor 120, and the inter-vehicle communicator 130 on the information detector 100 is configured to be outputted to the driving support apparatus 200. The information detector 100 may not include all of the vehicle exterior sensor 110, the vehicle interior sensor 120, and the inter-vehicle communicator 130, and may be provided with any of the vehicle exterior sensor 110, the vehicle interior sensor 120, and the inter-vehicle communicator 130, or another device that replaces them (i.e., a device configured to somehow detect information about the host vehicle or the other vehicle or the like).

The driving support apparatus 200 is a controller unit configured or programmed to control each part of the vehicle 10, and is configured or programmed to perform a collision avoidance control for avoiding a collision of the vehicle 10. The driving support apparatus 200 is provided with an information acquirer 210, a collision possibility determinator 220, a travel aspect change predictor 230, an assist control determinator 240, and an assist control executor 250.

The information acquirer 210 is configured to obtain each of the information detected by the vehicle exterior sensor 110, the vehicle interior sensor 120, and the inter-vehicle communicator 130 of the information detector 100. Each of the information obtained by the information acquirer 210 is configured to be outputted to each of the collision possibility determinator 220 and the travel aspect change predictor 230. The information acquirer 210 may be also configured to perform a predetermined process (e.g., an analysis process, an arithmetic process, etc.) on the various information obtained from the information detector 100, and may be configured to output resultant information. The information acquirer 210 is a specific example of the “acquirer” in Supplementary Notes described later.

The collision possibility determinator 220 is configured to determine whether or not there is a possibility (hereinafter referred to as a “collision possibility” as occasion demands) that the host vehicle 10 collides with another vehicle that exists around the host vehicle 10. Specifically, the collision possibility determinator 220 may use the information about the host vehicle 10 inputted from the information acquirer 210 (e.g., a position, a speed, acceleration, or the like of the host vehicle 10) and the information about the other vehicle (e.g., a position, a speed, acceleration, or the like of the of the other vehicle), thereby determining whether or not there is a possibility that the host vehicle 10 collides with the other vehicle. If there is a plurality of other vehicles around the host vehicle 10, the collision possibility may be determined for each of the other vehicles.

The collision possibility determinator 220 is further configured to determine a possibility that one vehicle that is determined to have a possibility of colliding with the host vehicle 10 collides with another vehicle (excluding the host vehicle 10). In other words, the collision possibility determinator 220 is configured to also determine whether or not vehicles other than the host vehicle 10 collide with each other. The collision possibility determinator 220 may use the information about the one vehicle and the other vehicle, which is inputted from the information acquirer 210, thereby determining whether or not there is a possibility that the one vehicle collides with the other vehicle. If there is a plurality of other vehicles that possibly collide with the one vehicle, the collision possibility may be determined for each of the other vehicles.

A more specific method of determining the collision possibility on the collision possibility determinator 220 can adopt the existing technologies/techniques, as occasion demands, and a detailed explanation will be thus omitted. A determination result by the collision possibility determinator 220, i.e., the collision possibility between the host vehicle 10 and one vehicle and the collision possibility between the one vehicle and another vehicle, is configured to be outputted to the travel aspect change predictor 230.

The travel aspect change predictor 230 is configured to predict whether or not a travel aspect of one vehicle that is determined to have a possibility of colliding with the host vehicle 10 changes due to the presence of another vehicle that has a possibility of colliding with the one vehicle. The “change in the travel aspect” here may mean a change in a parameter that influences the possibility of colliding with the host vehicle 10, out of various parameters regarding the travel of the one vehicle, such as, for example, a change in a travel route of the one vehicle for avoiding a collision with the other vehicle, and a change in a vehicle speed or acceleration. The travel aspect change predictor 230 may use the information about the one vehicle and the other vehicle, which is inputted from the information acquirer 210, thereby predicting whether or not the travel aspect of the one vehicle changes. A specific prediction operation of the travel aspect change predictor 230 will be detailed later. A prediction result by the travel aspect change predictor 230 is configured to be outputted to the assist control determinator 240. The travel aspect change predictor 230 is a specific example of the “predictor” in Supplementary Notes described later.

The assist control determinator 240 is configured to determine whether or not a collision avoidance assist control for avoiding the collision between the host vehicle 10 and the one vehicle is to be performed, on the basis of the prediction result of the travel aspect change predictor 230. A specific determination operation of the assist control determinator 240 will be detailed later. The assist control determinator 240 is configured to control an operation of the assist control executor 250 in accordance with a determination result. The assist control determinator 240 is a specific example of the “controller” in Supplementary Notes described later.

The assist control executor 250 is configured to perform a collision avoidance assist control for avoiding the collision between the host vehicle 10 and the other vehicle, by controlling an operation of each part of the host vehicle 10 (e.g., an accelerator opening degree, a brake amount, a steering amount, etc.). In the first embodiment, the collision avoidance assist control is not particularly limited to any specific control, but it is hereinafter assumed that a pre-crash safety (PCS) control is performed as the collision avoidance assist control. The assist control executor 250 is a specific example of the “executor” in Supplementary Notes described later.

<Specific Example of Collision Case>

Next, with reference to FIG. 2, a specific explanation will be given to a case in which an operation of the driving support apparatus 200 according to the first embodiment is expected, i.e., a case in which the host vehicle 10 has a possibility of colliding with another vehicle. FIG. 2 is a plan view illustrating an example of a collision case assumed by the driving support apparatus according to the first embodiment.

As illustrated in FIG. 2, the operation of the driving support apparatus 200 according to the first embodiment is based on the presence of two vehicles (specifically, another vehicle 20 and an oncoming vehicle 30) in addition to the host vehicle 10.

The other vehicle 20 is a vehicle that is about to enter a lane on which the host vehicle 10 is driving, i.e., a lane extending in a vertical direction of FIG. 2, from a lane of another road of a T junction, i.e., a lane extending in a horizontal direction of FIG. 2. Here, in particular, when the other vehicle 20 is about to turn right and enter the lane on which the host vehicle 10 is driving, there is a possibility that the host vehicle 10 and the other vehicle 20 collide with each other, depending on its timing. In other words, the other vehicle 20 may be a vehicle corresponding to the “one vehicle” in the above explanation, and is a specific example of the “second vehicle” in Supplementary Notes described later.

On the other hand, the oncoming vehicle 30 is a vehicle that is driving on an opposite lane of the lane on which the host vehicle 10 is driving. The oncoming vehicle 30 has no possibility of colliding with the host vehicle 10 as long as the oncoming vehicle 30 keeps driving on the current lane, but has a possibility of colliding with the other vehicle 20 that enters from the lane extending in the horizontal direction. In other words, the oncoming vehicle 30 may be a vehicle corresponding to “another vehicle or the other vehicle” in the above explanation, and is a specific example of the “third vehicle” in Supplementary Notes described later.

In the aforementioned case, the driving support apparatus 200 according to the first embodiment is configured to perform the PCS control in accordance with the behavior of the other vehicle 20. Specifically, whether or not to perform the PCS control may be determined, depending on whether or not a travel aspect of the other vehicle 20 changes due to the presence of the oncoming vehicle 30.

A situation in which the driving support apparatus 200 according to the first embodiment operates is not necessarily limited to the example of the T junction illustrated in FIG. 2. In other words, a moving direction of each vehicle is not limited as in the example of FIG. 2. For example, the driving support apparatus 200 according to the first embodiment can operate even on a straight road, a curve, a crossroad, a junction, a branch passage, or a turnaround. In the example of FIG. 2, all the moving directions of the vehicles are different from each other; however, even if any two or all of the vehicle 10, the other vehicle 20, and the oncoming vehicle 30 drive in the same direction, the driving support apparatus 200 according to the first embodiment can operate.

<Explanation of Operation>

Next, a flow of operations of the driving support apparatus 200 according to the first embodiment will be explained with reference to FIG. 3. FIG. 3 is a flowchart illustrating the flow of the operations of the driving support apparatus according to the first embodiment.

As illustrated in FIG. 3, in operation of the driving support apparatus 200 according to the first embodiment, firstly, the collision possibility determinator 220 determines whether or not there is a possibility that the host vehicle 10 collides with the other vehicle 20 (step S101). The collision possibility here may not be strictly determined. It may be determined that there is the collision possibility as long as there is a possibility, even a little, that the host vehicle 10 collides with the other vehicle 20, i.e., unless it can be said that the vehicles never collide with each other. If it is determined that there is no possibility that the host vehicle 10 collides with the other vehicle 20 (the step S101: NO), the operation of the PCS control is prohibited because it is not necessary to perform the PCS control to avoid the collision with the other vehicle 20 (step S104). Specifically, the assist control determinator 240 may control the assist control executor 250 to prohibit the operation of the PCS control. The prohibition of the operation of the PCS control here is performed merely for the PCS control performed in relation to the other vehicle 20. The PCS control may be performed if there is a possibility that the host vehicle 10 collides with a vehicle other than the other vehicle 20.

If it is determined that there is the possibility that the host vehicle 10 collides with the other vehicle 20 (the step S101: YES), the collision possibility determinator 220 further determines whether or not there is a possibility that the other vehicle 20 collides with the oncoming vehicle 30 (step S102). The collision possibility here may not be strictly determined. It may be determined that there is the collision possibility as long as there is a possibility, even a little, that the other vehicle 20 collides with the oncoming vehicle 30. If it is determined that there is no possibility that the other vehicle 20 collides with the oncoming vehicle 30 (the step S102: NO), it can be determined that the subsequent movement of the other vehicle 20 does not influence the oncoming vehicle 30. Specifically, the other vehicle 20 can keep driving without consideration of the collision with the oncoming vehicle 30, and thus, the other vehicle 20 likely enters the lane on which the host vehicle 10 is driving. Thus, in this case, the operation of the PCS control is permitted (step S105). The permission of the operation of the PCS control here does not mean immediate execution of the PCS control (e.g., an automatic brake control, etc.). The PCS control may not be performed if it can be determined that there is actually no possibility of the collision, even when the operation of the PCS control is permitted.

If it is determined that there is the possibility that the other vehicle 20 collides with the oncoming vehicle 30 (the step S102: YES), the travel aspect change predictor 230 determines whether or not the other vehicle 20 changes the travel aspect (step S103). Specifically, the travel aspect change predictor 230 may calculate a collision point at which the other vehicle 20 may collide with the oncoming vehicle 30, and may use a time to collision, which is a time required for each of the other vehicle 20 and the oncoming vehicle 30 to arrive at the collision point, thereby determining (i.e., predicting) whether or not the other vehicle 20 changes the travel aspect.

Here, a method of calculating the collision point between the other vehicle 20 and the oncoming vehicle 30 will be specifically explained with reference to FIG. 4. FIG. 4 is a graph illustrating the method of calculating the collision point between the oncoming vehicle and the other vehicle.

As illustrated in FIG. 4, a front end of the host vehicle 10 is set as a reference (0, 0), a distance L in the moving direction of the host vehicle 10 (i.e., a distance in a vertical direction of FIG. 2) is set on a vertical axis, and a distance W of the host vehicle 10 in a lateral direction (i.e., a distance in a horizontal direction of FIG. 2) is set on a horizontal axis. From a position of the oncoming vehicle 30 (i.e., a position indicated by a circle in FIG. 2) and a position of the other vehicle 20 (i.e., a position indicated by a triangle in FIG. 2), a position of a collision point X (i.e., a position indicated by a square in FIG. 2) can be calculated. More specifically, an intersection between a straight line that connects a position (L₁₁, W₁₁) at a time point T1 and a position (L₁₂, W₁₂) at a time point T2 of the oncoming vehicle 30, and a straight line that connects a position (L₂₁, W₂₁) at the time point T1 and a position (L₂₂, W₂₂) at the time point T2 of the other vehicle 20, may be calculated as a position (L_{C}, W_{C}) of the collision point X.

If the position of the collision point X is known, it is possible to calculate a time to collision TTC₁ for the oncoming vehicle 30 to arrive at the collision point and a time to collision TTC₂ for the other vehicle 20 to arrive at the collision point. Specifically, the time to collision TTC₁ and the time to collision TTC₂ can be respectively calculated by using the following equations (1) and (2), wherein D₁ is a distance between a current position of the oncoming vehicle 30 and the collision point X, D₂ is a distance between a current position of the other vehicle 20 and the collision point X, V₁ is a current speed of the oncoming vehicle 30, and V₂ is a current speed of the other vehicle 20.

TTC₁=D₁/V₁ (1)

TTC₂=D₂/V₂ (2)

Next, a method of determining whether or not the other vehicle 20 changes the travel aspect by using the time to collision TTC₁ and the time to collision TTC₂ will be specifically explained with reference to FIG. 5. FIG. 5 is a table indicating conditions for determining whether or not the other vehicle changes the travel aspect due to the presence of the oncoming vehicle.

As illustrated in FIG. 5, whether or not the other vehicle 20 changes the travel aspect is determined depending on whether or not any of the conditions is satisfied. ΔTTC₁₂ is a difference between the time to collision of the oncoming vehicle 30 and the time to collision of the other vehicle 20, and can be calculated by the following equation (3).

ΔTTC₁₂=TTC₁−TTC₂ (3)

Moreover, A₂ᵢ is a deceleration required for the other vehicle 20 to stop at the collision point X, and can be calculated by the following equation (4).

A₂ᵢ=V₂/TTC₂ (4)

Each of threshold values t1 and t2 in the determination conditions may be a value set to determine whether or not there is a difference, which is large enough to avoid the collision between the oncoming vehicle 30 and the other vehicle 20, between the time to collision TTC₁ of the oncoming vehicle 30 and the time to collision TTC₂ of the other vehicle 20. Specifically, if ΔTTC₁₂>a threshold value t1 (wherein the threshold value t1 is a positive value) is satisfied, the other vehicle 20 arrives at the collision point sufficiently earlier than the oncoming vehicle 30 does. It is thus possible to determine that the other vehicle 20 crosses ahead of or in front of the oncoming vehicle 30 while maintaining the travel aspect. Thus, if this determination condition is satisfied, it is determined that the other vehicle 20 does not change the travel aspect. In the same manner, if ΔTTC₁₂<a threshold value t2 (wherein the threshold value t2 is a negative value) is satisfied, the other vehicle 20 arrives at the collision point sufficiently later than the oncoming vehicle 30 does. It is thus possible to determine that the other vehicle 20 crosses behind the oncoming vehicle 30 while maintaining the travel aspect. Thus, if this determination condition is satisfied, it is determined that the other vehicle 20 does not change the travel aspect.

Each of threshold values t3 and a1 in the determination conditions may be a value set to determine that the other vehicle 20 cannot stop before arriving at the collision point X. Specifically, if the time to collision TTC₂<the threshold value t3 is satisfied, the time required to arrive at the collision point X is extremely short, i.e., the other vehicle 20 cannot stop even if starting to decelerate at that time point. It is thus possible to determine that the other vehicle 20 passes the collision point X while maintaining the travel aspect. Thus, if this determination condition is satisfied, it is determined that the other vehicle 20 does not change the travel aspect. In the same manner, if the deceleration A₂₁<the threshold value a1 is satisfied, the deceleration for stopping at the collision point is so high that the other vehicle 20 cannot stop even if starting to decelerate at that time point, i.e., the possibility of changing the travel aspect is extremely low due to the presence of the oncoming vehicle 30. It is thus possible to determine that the other vehicle 20 passes the collision point X while maintaining the travel aspect. Thus, if this determination condition is satisfied, it is determined that the other vehicle 20 does not change the travel aspect.

As described above, if any of the plurality of conditions illustrated in FIG. 5 is satisfied, it is determined that the other vehicle 20 does not change the travel aspect. In other words, if none of the plurality of conditions illustrated in FIG. 5 is satisfied, it is determined that the other vehicle 20 changes the travel aspect. The determination conditions in FIG. 5 are merely an example. In addition to or instead of these determination conditions, another determination condition may be set.

Back in FIG. 3, if it is determined that the other vehicle 20 changes the travel aspect due to the presence of the oncoming vehicle 30 (the step S103: YES), the assist control determinator 240 controls the assist control executor 250 to prohibit the operation of the PCS control (step S104). On the other hand, if it is determined that the other vehicle 20 does not change the travel aspect due to the presence of the oncoming vehicle 30 (the step S103: NO), the assist control determinator 240 controls the assist control executor 250 to permit the operation of the PCS control (step S105).

<Technical Effect>

Next, a technical effect obtained by the driving support apparatus 200 according to the first embodiment will be explained.

As described above, according to the driving support apparatus 200 in the first embodiment, whether or not to operate the PCS control is determined depending on whether or not the other vehicle 20 changes the travel aspect due to the presence of the oncoming vehicle 30. In this manner, it is possible to prevent the PCS control from being unnecessarily performed while avoiding the collision between the host vehicle 10 and the other vehicle 20.

Specifically, if the other vehicle 20 does not change the travel aspect due to the presence of the oncoming vehicle 30, the other vehicle 20 is expected to move to the host vehicle 10 side in the same travel aspect as before. Thus, in this case, the permission of the PCS control allows the PCS control to be performed in proper timing, by which the collision between the host vehicle 10 and the other vehicle 20 is avoided. On the other hand, if the other vehicle 20 changes the travel aspect due to the presence of the oncoming vehicle 30, the other vehicle 20 is expected to start to decelerate (or increase the deceleration) or to change a travel route in order to avoid the collision with the oncoming vehicle 30. Thus, in this case, the change in the travel aspect of the other vehicle 20 may significantly reduce the collision possibility between the host vehicle 10 and the other vehicle 20. It is thus possible to prevent the PCS control from being unnecessarily performed by prohibiting the PCS control.

### Second Embodiment

Next, a driving support apparatus 200 according to a second embodiment will be explained with reference to FIG. 6 to FIG. 9. The second embodiment is partially different in the operation from the first embodiment, but is substantially the same in the other part. Thus, hereinafter, a different part from that of the first embodiment will be explained in detail, and an explanation of the other same part will be omitted.

<Explanation of Operation>

Firstly, a flow of operations of the driving support apparatus 200 according to the second embodiment will be explained with reference to FIG. 6. FIG. 6 is a flowchart illustrating the flow of the operations of the driving support apparatus according to the second embodiment. In FIG. 6, the same steps as those illustrated in FIG. 3 will carry the same reference numerals.

As illustrated in FIG. 6, in operation of the driving support apparatus 200 according to the second embodiment, as in the first embodiment already explained above, if it is determined that there is the possibility that the host vehicle 10 collides with the other vehicle 20 (the step S101: YES) and if it is determined that there is the possibility that the other vehicle 20 collides with the oncoming vehicle 30 (the step S102: YES), the travel aspect change predictor 230 determines whether or not the other vehicle 20 changes the travel aspect (the step S103).

Particularly in the second embodiment, if it is determined that the other vehicle 20 changes the travel aspect (the step S103: YES), it is determined whether or not a distance between the host vehicle 10 and the other vehicle 20 is less than a threshold value R1 (step S201). In a determination process in the step S201, it is determined whether or not the distance between the host vehicle 10 and the other vehicle 20 is so close that it is risky if the operation of the PCS control is prohibited, by comparing the distance with the threshold value R1. The threshold value R1 may be set as follows. For example, a relation between (i) the distance between the host vehicle 10 and the other vehicle 20 and (ii) a possibility of the collision between the host vehicle 10 and the other vehicle 20 even when the other vehicle 20 changes the travel aspect, may be obtained by experiments, experiences, or simulations. On the basis of the obtained relation, the threshold value R1 may be set as a maximum value of a range of the aforementioned distance in which the aforementioned possibility of the collision is too high to allow the prohibition of the operation of the PCS control, or as a value that is greater than the maximum value by a predetermined value.

If it is determined that the distance between the host vehicle 10 and the other vehicle 20 is not less than the threshold value R1 (the step S201: NO), the operation of the PCS control is prohibited (the step S104). On the other hand, if it is determined that the distance between the host vehicle 10 and the other vehicle 20 is less than the threshold value R1 (the step S201: YES), the operation of the PCS control is not prohibited but is permitted (the step S105).

Now, the determination process in the step S201 will be specifically explained with reference to FIG. 7. FIG. 7 is a plan view illustrating an example of a case in which the host vehicle is close to the other vehicle 20.

As illustrated in FIG. 7, if the PCS control is prohibited on the basis of the prediction that the other vehicle 20 changes the travel aspect when the distance between the host vehicle 10 and the other vehicle 20 is close, the host vehicle 10 has a possibility of colliding with the other vehicle 20 if the other vehicle 20 takes an unexpected action. Thus, even if it is predicted that the other vehicle 20 changes the travel aspect, if the distance between the host vehicle 10 and the other vehicle 20 is less than the threshold value R1, the operation of the PCS control is not prohibited but is permitted. In this manner, it is possible to more certainly avoid the collision between the host vehicle 10 and the other vehicle 20.

The threshold value R1 may be set for a distance L_{B} between the host vehicle 10 and the other vehicle 20 in the moving direction, or may be set for a distance W_{B} between the host vehicle 10 and the other vehicle 20 in the lateral direction. Alternatively, there may be two threshold values R1 which are separately set for the distance L_{B} and the distance W_{B}. In that case, it may be determined that both of the distance L_{B} and the distance W_{B} are respectively less than the corresponding threshold values.

Back in FIG. 6, in the second embodiment, moreover, if it is determined that the other vehicle 20 does not change the travel aspect (the step S103: NO), it is determined whether or not a distance between the host vehicle 10 and the collision point X is greater than or equal to a threshold value R2 (step S202). The threshold value R2 may be set as a threshold value for determining whether or not the distance between the host vehicle 10 and the collision point X is far enough to determine that the collision can be avoided even without execution of the PCS control.

If it is determined that the distance between the host vehicle 10 and the collision point X is not greater than or equal to the threshold value R2 (the step S202: NO), the operation of the PCS control is permitted (step S105). On the other hand, if it is determined that the distance between the host vehicle 10 and the collision point X is greater than or equal to the threshold value R2 (the step S202: YES), the operation of the PCS control is not permitted but is prohibited (the step S104).

Now, the determination process in the step S202 will be specifically explained with reference to FIG. 8 and FIG. 9. FIG. 8 is a plan view illustrating an example of a case in which the host vehicle is far from the collision point. FIG. 9 is a map illustrating an operation permission area and an operation prohibition area of a PCS control.

As illustrated in FIG. 8, if the PCS control is permitted on the basis of the prediction that the other vehicle 20 does not change the travel aspect when the distance between the host vehicle 20 and the collision point X is far, the PCS control is possibly performed even if the collision possibility of the host vehicle 10 is low. In other words, as illustrated in FIG. 8, the PCS control is possibly performed as an operation for the other vehicle 20 that is extremely far from the host vehicle 10. Thus, even if it is predicted that the other vehicle 20 does not change the travel aspect, if the distance between the host vehicle 10 and the collision point X is greater than or equal to the threshold value R2, the operation of the PCS control is not permitted but is prohibited. It is thus possible to prevent the PCS control from being unnecessarily performed.

The threshold value R2 may be set for a distance L_{C} between the host vehicle 10 and the collision point X in the moving direction, or may be set for a distance W_{C} between the host vehicle 10 and the collision point X in the lateral direction. Alternatively, there may be two threshold values R2 which are separately set for the distance L_{C} and the distance W_{C}. In that case, it may be determined that at least one of the distance L_{C} and the distance W_{C} is less than respective one of the corresponding threshold values.

As illustrated in FIG. 9, if a threshold value Lth corresponding to the distance L_{C} and a threshold value Wth corresponding to the distance W_{C} are set as the threshold value R2, an area that is within the distance Lth and the distance Wth from the front end (0, 0) of the host vehicle 10 is a PCS operation permission area in which the operation of the PCS is permitted. On the other hand, an area that is far from the front end (0, 0) of the host vehicle by more than the distance Lth or the distance Wth is a PCS operation prohibition area in which the operation of the PCS is prohibited.

<Technical Effect>

Next, a technical effect obtained by the driving support apparatus 200 according to the second embodiment will be explained.

As explained with reference to FIG. 6 to FIG. 9, according to the driving support apparatus 200 in the second embodiment, whether or not to perform the PCS control is determined in view of the distance between the host vehicle 10 and the other vehicle 20 and the distance between the host vehicle 10 and the collision point X, in addition to the condition that is whether or not the other vehicle 20 changes the travel aspect due to the presence of the oncoming vehicle 20. It is thus possible to more appropriately determine whether or not to perform the PCS control, in comparison with when using only the condition that is whether or not the other vehicle 20 changes the travel aspect.

### Third Embodiment

Next, a driving support apparatus 200 according to a third embodiment will be explained with reference to FIG. 10. The third embodiment is partially different in the operation from the first and second embodiments, but is substantially the same in the other part. Thus, hereinafter, a different part from those of the first and second embodiments will be explained in detail, and an explanation of the other same part will be omitted.

<Explanation of Operation>

The content of operations of the driving support apparatus 200 according to the third embodiment will be explained with reference to FIG. 10. FIG. 10 is a plan view illustrating a method of determining giving way or yielding the right of way on the driving support apparatus 200 according to the third embodiment.

In operation of the driving support apparatus 200 according to the third embodiment, when it is determined whether or not the other vehicle 20 changes the travel aspect due to the presence of the oncoming vehicle 30, i.e., in the step S103 in FIG. 3 and in FIG. 6, the determination is performed by predicting whether or not the oncoming vehicle 30 gives way or yields the right of way to the other vehicle 20.

As illustrated in FIG. 10, whether or not the oncoming vehicle 30 gives way to the other vehicle 20 may be determined on the basis of a positional relation among the host vehicle 10, the other vehicle 20, and the oncoming vehicle 30, or the behavior of the other vehicle 20 and the oncoming vehicle 30, or the like.

Specifically, in a situation in which a right turn indicator of the other vehicle 20 is blinking, if the oncoming vehicle 30 performs an action for giving way, such as passing, sounding a horn, or the driver raising his or her hand, then, it is determined that the oncoming vehicle 30 gives way to the other vehicle 20. In this case, the other vehicle 20 drives in preference to the oncoming vehicle 30. It is thus possible to determine that the other vehicle 20 does not change the travel aspect due to the presence of the oncoming vehicle 30.

In a situation in which a distance L_{A} between the host vehicle 10 and the oncoming vehicle 30 is greater than a value obtained by adding a margin value to a distance L_{B} between the host vehicle 10 and the other vehicle 20 (i.e., the oncoming vehicle 30 is farther than the other vehicle 20 as viewed from the host vehicle 10), if the deceleration of the oncoming vehicle 30 is less than a predetermined deceleration, or if the speed of the oncoming vehicle 30 changes by more than a predetermined amount (i.e., if the oncoming vehicle 30 decelerates), or if a brake ON of the oncoming vehicle 30 or a change from ON to OFF of an accelerator is detected in an inter-vehicle communication or the like, then, it is determined that the oncoming vehicle 30 decelerates to give way to the other vehicle 20. Even in this case, the other vehicle 20 drives in preference to the oncoming vehicle 30. It is thus possible to determine that the other vehicle 20 does not change the travel aspect due to the presence of the oncoming vehicle 30.

In a situation in which the distance L_{A} between the host vehicle 10 and the oncoming vehicle 30 is greater than the value obtained by adding the margin value to the distance L_{B} between the host vehicle 10 and the other vehicle 20, if the oncoming vehicle 30 approaches to the other vehicle 20 side (specifically, if a distance W_{D} between the oncoming vehicle 30 and the other vehicle 20 in the lateral direction decreases by more than a predetermined amount), or if a left turn indicator of the oncoming vehicle 30 is blinking, then, it is determined that the other vehicle 20 is about to turn left to the lane of the oncoming vehicle 30. In this case, the travel route of the other vehicle 20 does not cross the travel route of the oncoming vehicle 30. It is thus possible to determine that the other vehicle 20 does not change the travel aspect due to the presence of the oncoming vehicle 30.

<Technical Effect>

Next, a technical effect obtained by the driving support apparatus 200 according to the third embodiment will be explained.

As explained with reference to FIG. 10, according to the driving support apparatus 200 in the third embodiment, whether or not the other vehicle 20 changes the travel aspect by whether or not the oncoming vehicle 30 gives way to the other vehicle 20. It is thus possible to appropriately determine whether or not to perform the PCS control without using the time to collision unlike the first and second embodiments. The aforementioned determination example of the give way is merely an example. In addition to or instead of the aforementioned determination example, another condition may be also used.

<Supplementary Notes>

Various aspects of embodiments of the present disclosure derived from the embodiments explained above will be explained hereinafter.

(Supplementary Note 1)

A driving support apparatus described in Supplementary Note 1 is provided with: an executor configured to perform a collision avoidance assist control for avoiding a collision with another vehicle, on a first vehicle; an acquirer configured to obtain surrounding information including information about a second vehicle, which has a possibility of colliding with the first vehicle, and information about a third vehicle, which has a possibility of colliding with the second vehicle; a predictor configured to predict whether or not the second vehicle changes a travel aspect due to a presence of the third vehicle, on the basis of the surrounding information; and a controller programmed (i) to control the executor not to perform the collision avoidance assist control for avoiding the collision with the second vehicle if it is predicted that the second vehicle changes the travel aspect due to the presence of the third vehicle, and (ii) to control the executor to perform the collision avoidance assist control for avoiding the collision with the second vehicle if it is predicted that the second vehicle does not change the travel aspect due to the presence of the third vehicle.

According to the driving support apparatus described in Supplementary Note 1, if it is predicted that the second vehicle, which is another vehicle that is a target of the collision avoidance assist control of the first vehicle, changes the travel aspect due to the presence of the third vehicle, the collision avoidance assist control is not performed. In this manner, even when the collision possibility between the first vehicle and the second vehicle is low due to the change in the travel aspect of the second vehicle, it is possible to avoid the execution of the collision avoidance assist control. In other words, it is possible to prevent the collision avoidance assist control from being unnecessarily performed while preventing the collision between the vehicles, by determining whether or not to perform the collision avoidance assist control depending on situations.

(Supplementary Note 2)

In the driving support apparatus described in Supplementary Note 2, the predictor is configured to calculate, from the surrounding information, at least one of a first time to collision, which is a time required for the second vehicle to arrive at a collision point at which the second vehicle possibly collides with the third vehicle, and a second time to collision, which is a time required for the third vehicle to arrive at the collision point, and the predictor is configured to predict whether or not the second vehicle changes the travel aspect due to the presence of the third vehicle, on the basis of the at least one time to collision.

According to the driving support apparatus described in Supplementary Note 2, it is possible to predict whether or not the second vehicle changes the travel aspect, easily and accurately, by using at least one of the first time to collision and the second time to collision.

(Supplementary Note 3)

In the driving support apparatus described in Supplementary Note 3, the controller is programmed to control the executor to perform the collision avoidance assist control for avoiding the collision with the second vehicle if a distance between a position of the first vehicle and a position of the second vehicle is less than a first predetermined distance, even when it is predicted that the second vehicle changes the travel aspect due to the presence of the third vehicle.

According to the driving support apparatus described in Supplementary Note 3, the collision avoidance assist control is performed if such a condition that the distance between the first vehicle and the second vehicle is less than the first predetermined distance is satisfied, even when the second vehicle changes the travel aspect and the collision avoidance assist control is originally not to be necessarily performed. The “first predetermined distance” may be a threshold value for determining that there is a high possibility that the first vehicle collides with the second vehicle, regardless of whether or not the second vehicle changes the travel aspect. Thus, the use of the first predetermined distance makes it possible to accurately determine the high collision possibility caused by the proximity of the first vehicle to the second vehicle, by which it is possible to perform the collision avoidance assist control. In other words, it is possible to prevent the collision avoidance assist control from being prohibited even when the actual collision possibility is high only because the second vehicle changes the travel aspect.

(Supplementary Note 4)

In the driving support apparatus described in Supplementary Note 4, the controller is programmed to control the executor not to perform the collision avoidance assist control for avoiding the collision with the second vehicle if a distance between a position of the first vehicle and a position of a collision point at which the second vehicle possibly collides with the third vehicle is greater than or equal to a second predetermined distance, even when it is predicted that the second vehicle does not change the travel aspect due to the presence of the third vehicle.

According to the driving support apparatus described in Supplementary Note 4, the collision avoidance assist control is not performed if such a condition that the distance between (i) the first vehicle and (ii) the collision point of the second vehicle and the third vehicle is greater than or equal to the second predetermined distance is satisfied, even when the second vehicle does not change the travel aspect and the collision avoidance assist control is originally to be performed. The “second predetermined distance” may be a threshold value for determining that there is a low possibility that the first vehicle collides with the second vehicle, regardless of whether or not the second vehicle changes the travel aspect. Thus, the use of the second predetermined distance makes it possible to accurately determine the low collision possibility caused by the remoteness of the first vehicle from the collision point, by which it is possible to perform the collision avoidance assist control. In other words, it is possible to prevent the collision avoidance assist control from being performed even when the actual collision possibility is low only because the second vehicle does not change the travel aspect.

(Supplementary Note 5)

In the driving support apparatus described in Supplementary Note 5, the predictor is configured to determine, from the surrounding information, whether or not the third vehicle preferentially allows the second vehicle to pass to a side of the first vehicle at a position of a collision point at which the second vehicle possibly collides with the third vehicle, and the predictor is configured (i) to predict that the second vehicle does not change the travel aspect due to the presence of the third vehicle if it is determined that the third vehicle preferentially allows the second vehicle to pass to the side of the first vehicle, and (ii) to predict that the second vehicle changes the travel aspect due to the presence of the third vehicle if it is determined that the third vehicle does not preferentially allows the second vehicle to pass to the side of the first vehicle.

According to the driving support apparatus described in Supplementary Note 4, whether or not the second vehicle changes the travel aspect is predicted depending on whether or not the third vehicle preferentially allows the second vehicle to pass to the side of the first vehicle (in other words, whether or not the third vehicle gives way to the second vehicle). Specifically, if the third vehicle gives way to the second vehicle, it can be determined that the second vehicle does not change the travel aspect (e.g., the second vehicle can continue to drive while maintaining the speed). On the other hand, if the third vehicle does not give way to the second vehicle, it can be determined that the second vehicle changes the travel aspect (e.g., the second vehicle needs to deceleration to avoid the collision with the third vehicle). As described above, if consideration is given to a result of the give way between the second vehicle and the third vehicle, it is possible to predict the change in the travel aspect of the second vehicle.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A driving support apparatus comprising:
an executor configured to perform a collision avoidance assist control for avoiding a collision with another vehicle, on a first vehicle;
an acquirer configured to obtain surrounding information including information about a second vehicle, which has a possibility of colliding with the first vehicle, and information about a third vehicle, which has a possibility of colliding with the second vehicle;
a predictor configured to predict whether or not the second vehicle changes a travel aspect due to a presence of the third vehicle, on the basis of the surrounding information; and
a controller programmed (i) to control said executor not to perform the collision avoidance assist control for avoiding the collision with the second vehicle if it is predicted that the second vehicle changes the travel aspect due to the presence of the third vehicle, and (ii) to control said executor to perform the collision avoidance assist control for avoiding the collision with the second vehicle if it is predicted that the second vehicle does not change the travel aspect due to the presence of the third vehicle.

2. The driving support apparatus according to claim 1, wherein said predictor is configured to calculate, from the surrounding information, at least one of a first time to collision, which is a time required for the second vehicle to arrive at a collision point at which the second vehicle possibly collides with the third vehicle, and a second time to collision, which is a time required for the third vehicle to arrive at the collision point, and said predictor is configured to predict whether or not the second vehicle changes the travel aspect due to the presence of the third vehicle, on the basis of the at least one time to collision.

3. The driving support apparatus according to claim 1, wherein said controller is programmed to control said executor to perform the collision avoidance assist control for avoiding the collision with the second vehicle if a distance between a position of the first vehicle and a position of the second vehicle is less than a first predetermined distance, even when it is predicted that the second vehicle changes the travel aspect due to the presence of the third vehicle.

4. The driving support apparatus according to claim 1, wherein said controller is programmed to control said executor not to perform the collision avoidance assist control for avoiding the collision with the second vehicle if a distance between a position of the first vehicle and a position of a collision point at which the second vehicle possibly collides with the third vehicle is greater than or equal to a second predetermined distance, even when it is predicted that the second vehicle does not change the travel aspect due to the presence of the third vehicle.

5. The driving support apparatus according to claim 1, wherein said predictor is configured to determine, from the surrounding information, whether or not the third vehicle preferentially allows the second vehicle to pass to a side of the first vehicle at a position of a collision point at which the second vehicle possibly collides with the third vehicle, and said predictor is configured (i) to predict that the second vehicle does not change the travel aspect due to the presence of the third vehicle if it is determined that the third vehicle preferentially allows the second vehicle to pass to the side of the first vehicle, and (ii) to predict that the second vehicle changes the travel aspect due to the presence of the third vehicle if it is determined that the third vehicle does not preferentially allows the second vehicle to pass to the side of the first vehicle.
